(19) United States
(12) Patent Application Publication
(10) Pub. No.: US 2025/0035143 A1
(43) Pub. Date: Jan. 30, 2025

(54) Coupling Mechanisms and Structures for Modular Units

(71) Applicant: Milwaukee Electric Tool Corporation, Brookfield, WI (US)

(72) Inventors: Christian R. Braun, Milwaukee, WI (US); Grant T. Squiers, Cudahy, WI (US); Benjamin T. Jones, St. Francis, WI (US)

(21) Appl. No.: 18/743,819

(22) Filed: Jun. 14, 2024

Related U.S. Application Data
(60) Provisional application No. 63/515,657, filed on Jul. 26, 2023.

(51) Int. Cl. F16B 12/10; A47B 95/00

(52) U.S. Cl. CPC F16B 12/10; A47B 95/00; A47B 2230/0074

(57) ABSTRACT

Components of support platforms and coupling mechanisms within a modular system are provided. The support platforms include female couplers with ribs that couple with male couplers of utility modules. The female couplers of the support platforms and the male couplers of the utility modules are configured to facilitate coupling the utility modules to the support platforms.

### CROSS-REFERENCE TO RELATED PATENT APPLICATION

The present application claims the benefit of and priority to U.S. Application No. 63/515,657 filed on Jul. 26, 2023, which is incorporated herein by reference in its entirety.

### BACKGROUND OF THE INVENTION

The present disclosure is directed generally to the field of containers and related devices. The present disclosure relates specifically to coupling mechanisms for modular units, such as containers.

Tool storage units are often used to transport tools and tool accessories. Some storage units are designed to incorporate into a modular storage system. Various platforms can be configured to support units within a modular system. Discussed herein are structures for support platforms and utility modules within a modular system that facilitate coupling and decoupling the support platforms and utility modules.

### SUMMARY OF THE INVENTION

One embodiment of the invention relates to a support structure including a coupling interface. The coupling interface includes a rear wall, a front wall opposite the rear wall, a first sidewall extending between the rear wall and the front wall, a second sidewall opposite the first sidewall, the second sidewall extending between the rear wall and the front wall, a first rib extending from the first sidewall towards the second sidewall and from the rear wall towards the front wall, a second rib extending from the second sidewall towards the first sidewall and from the rear wall towards the front wall, a first moveable wing pivotally coupled to the first sidewall, and a second moveable wing pivotally coupled to the second sidewall. The first moveable wing pivots around a first axis with respect to the first sidewall. The first moveable wing actuates between extending from the first axis towards the rear wall, extending from the first axis towards the second sidewall, and extending from the first axis towards the front wall, and the first moveable wing is biased by a first biasing element to extend from the first axis towards the second sidewall. The second moveable wing pivots around a second axis with respect to the second sidewall. The second moveable wing actuates between extending from the second axis towards the rear wall, extending from the second axis towards the first sidewall, and extending from the second axis towards the front wall, and the second moveable wing is biased by a second biasing element to extend from the second axis towards the first sidewall.

Another embodiment of the invention relates to a utility module including a housing extending from a front to a rear opposite the front, a bottom surface defined by the housing, a retractable latch extending below the bottom surface from the front of the housing, a first rear male coupler extending from the bottom surface, and a first front male coupler extending from the bottom surface. The first rear male coupler includes a first body extending downward from the bottom surface, a first rib and a second rib extending from the first body away from each other, the first rib offset from the bottom surface to define a first channel, the second rib offset from the bottom surface to define a second channel, and the first channel and the second channel each extend uninterrupted towards the front of the housing. The first front male coupler includes a second body extending downward from the bottom surface, a third rib and a fourth rib extending from the second body away from each other, the third rib offset from the bottom surface to define a third channel, the fourth rib offset from the bottom surface to define a fourth channel. The first front male coupler includes a rear wall that blocks each of the third channel and the fourth channel from extending towards the front of the housing, and the third channel is colinear with the first channel and the fourth channel is colinear with the second channel.

Another embodiment of the invention relates to a support structure including a coupling interface. The coupling interface includes a rear wall, a front wall opposite the rear wall, a first sidewall extending between the rear wall and the front wall, a second sidewall opposite the first sidewall, the second sidewall extending between the rear wall and the front wall, a first rib extending from the first sidewall towards the second sidewall and from the rear wall towards the front wall, a second rib extending from the second sidewall towards the first sidewall and from the rear wall towards the front wall, and a retractable wing. The retractable wing actuates between an extended position and a retracted position. When the retractable wing is in the extended position the retractable wing extends past the first sidewall towards the second sidewall, and when the retractable wing actuates from the retracted position to the extended position the retractable wing moves towards the second sidewall.

Another embodiment of the invention relates to a utility module including a housing, the housing extending from a front to a rear opposite the front, a bottom surface defined by the housing, a latch extending below the bottom surface, a first rear male coupler extending from the bottom surface, and a first front male coupler extending from the bottom surface. The first rear male coupler includes a first body extending downward from the bottom surface, a first rib and a second rib extending from the first body away from each other. The first rib is offset from the bottom surface to define a first channel, and the second rib offset from the bottom surface to define a second channel. The first channel and the second channel each extend uninterrupted towards the first rear male coupler. The first front male coupler includes a second body extending downward from the bottom surface, a third rib and a fourth rib extending from the second body away from each other. The third rib is offset from the bottom surface to define a third channel, and the fourth rib is offset from the bottom surface to define a fourth channel. The first front male coupler includes a rear wall that blocks each of the third channel and the fourth channel. The third channel is colinear with the first channel and the fourth channel is colinear with the second channel.

Another embodiment of the invention relates to a support structure including a coupling interface including a front portion and a rear portion opposite the front portion, a rear wall and a front wall opposite the rear wall, a first sidewall, a second sidewall opposite the first sidewall, a first rib, a second rib, a first moveable wing pivotally coupled to the first sidewall, and a second moveable wing pivotally coupled to the second sidewall. The first sidewall and the second sidewall each extend from the rear wall towards the front wall and the front portion. The first rib extends from the first sidewall towards the second sidewall and from the rear wall towards the front wall. The second rib extends from the second sidewall towards the first sidewall and from the rear wall towards the front wall. The first moveable wing actuates between extending towards the rear wall, the second sidewall, and the front wall, and the first moveable wing is biased to extend towards the second sidewall by a first biasing element. The second moveable wing actuates between extending towards the rear wall, the first sidewall, and the front wall, and the second moveable wing is biased to extend towards the first sidewall by a second biasing element.

In various embodiments, the coupling interface includes a latch recess configured to receive a latch extending from a utility module. The first rib is configured to engage with a first male coupler extending from the utility module, the second rib is configured to engage with a second male coupler extending from the utility module, the first moveable wing is configured to engage with a third male coupler extending from the utility module, and the second moveable wing is configured to engage with a fourth male coupler extending from the utility module. The ribs and the latch collectively rigidly couple the utility module to the coupling interface.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a support platform, according to an exemplary embodiment.

FIG. 2 is a perspective view of a utility module, according to an exemplary embodiment.

FIG. 3 is a detailed perspective view of a portion of the utility module of FIG. 2, according to an exemplary embodiment.

FIG. 4 is a detailed perspective view of a portion of the utility module of FIG. 2, according to an exemplary embodiment.

FIG. 5 is a view of the utility module of FIG. 2 and the support platform of FIG. 1, according to an exemplary embodiment.

FIG. 6 is a view of the utility module of FIG. 2 and the support platform of FIG. 1, according to an exemplary embodiment.

FIG. 7 is a view of the utility module of FIG. 2 and the support platform of FIG. 1, according to an exemplary embodiment.

FIG. 8 is a view of the utility module of FIG. 2 and the support platform of FIG. 1, according to an exemplary embodiment.

FIG. 9 is a view of the utility module of FIG. 2 and the support platform of FIG. 1, according to an exemplary embodiment.

FIG. 10 is a perspective view of another support platform, according to another exemplary embodiment.

FIG. 11 is a detailed perspective view of a portion of the support platform of FIG. 10, according to an exemplary embodiment.

FIG. 12 is a detailed perspective view of a portion of the support platform of FIG. 10, according to an exemplary embodiment.

FIG. 13 is a detailed perspective view of a portion of the support platform of FIG. 10, according to an exemplary embodiment.

FIG. 14 is a view of a utility module and the support platform of FIG. 10, according to an exemplary embodiment.

FIG. 15 is a view of the utility module of FIG. 14 and the support platform of FIG. 10, according to an exemplary embodiment.

FIG. 16 is a view of the utility module of FIG. 14 and the support platform of FIG. 10, according to an exemplary embodiment.

FIG. 17 is a perspective schematic view of another support platform, according to another exemplary embodiment.

FIG. 18 is a perspective schematic view of the support platform of FIG. 17, according to an exemplary embodiment.

FIG. 19 is a perspective schematic view of another support platform and utility module, according to another exemplary embodiment.

FIG. 20 is a schematic side view of a portion of the support platform and utility module of FIG. 19, according to an exemplary embodiment.

FIG. 21 is a perspective schematic view of the support platform and utility module of FIG. 19, according to an exemplary embodiment.

FIG. 22 is a schematic side view of a portion of the support platform and utility module of FIG. 19, according to an exemplary embodiment.

FIG. 23 is a perspective view of a drawer with shelves, according to an exemplary embodiment.

### DETAILED DESCRIPTION

Referring generally to the figures, support platforms and utility modules within a modular system and utility modules are shown. The support platforms and utility modules described herein provide a coupling interface that helps users quickly couple and decouple utility modules from the support platforms.

In particular, provided herein are utility modules that slidably couple with support platforms so that the utility modules can be easily slid into engagement with the support platform. Applicant has observed that when sliding utility modules onto support modules, occasionally the incorrect couplers will engage (e.g., the rear male coupler engaging with the front female coupler), causing the user to have to disengage the couplers and lift up the utility module before reengaging the utility module to the support platform.

Provided herein are designs for utility modules and support platforms that allow users to slidingly engage the utility module and the support platform when they are initially above each other, rather than having the user lift the utility module until the rear couplers of the utility module are ready to engage the rear couplers of the support platform. For example, the support platforms and utility modules described herein may be used advantageously in shelving environments where the user may not be able to vertically support the utility module until the until the rear couplers of the utility module are ready to engage the rear couplers of the support platform, such as because the shelf immediately above does not provide enough space for the user.

The term ‘utility module’ is used hereinafter in its broad meaning and is meant to denote a variety of articles such as, storage containers, travel luggage, tool boxes, organizers, compacted work benches, cable storage, tools (e.g. hand tools, power generators and power sources), communication modules, carrying platforms, locomotion platforms, beverage containers, etc., of any shape and size, and wherein any utility module can be detachably attached to the modular system.

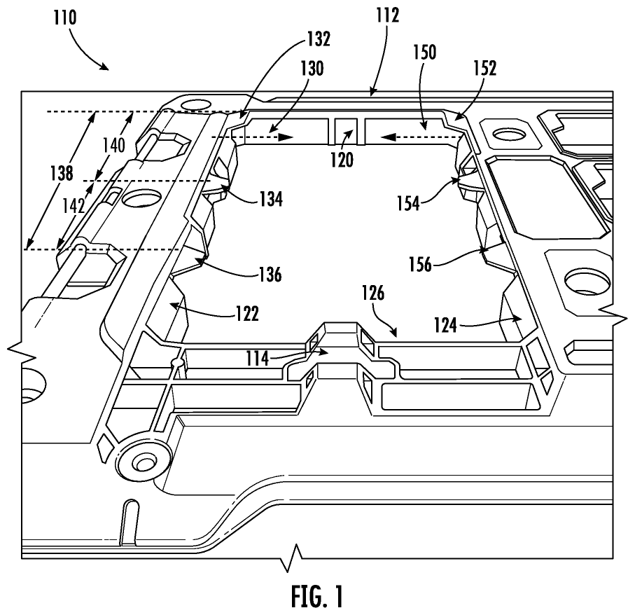

Referring to FIGS. 1-4, various aspects of a support structure, shown as plate 110, for engaging utility modules within a modular system are provided. Plate 110 includes latch recess 114 and a coupling interface 112. Coupling interface 112 is configured to slidingly and rigidly engage a utility module (e.g., utility module 210 shown in FIG. 2).

Coupling interface 112 includes rear wall 120, front wall 126 opposite rear wall 120, first sidewall 122 extending between rear wall 120 and front wall 126, and second sidewall 124 opposite first sidewall 122. Second sidewall 124 extends between front wall 126 and rear wall 120.

Coupling interface 112 includes first tongue 132 extending in direction 130 from first sidewall 122 towards second sidewall 124, and extending from rear wall 120 towards front wall 126. Coupling interface 112 also includes second tongue 134 extending in direction 130 from first sidewall 122 towards second sidewall 124, and third tongue 136 extending in direction 130 from first sidewall 122 towards second sidewall 124.

In various embodiments, the distance 140 from first tongue 132 to second tongue 134 and the distance 142 from second tongue 134 to third tongue 136 are between 40% to 60% of distance 138 between first tongue 132 to third tongue 136, and more specifically between 45% and 55%, and even more specifically 50%. Applicant has observed that spacing the tongues 132, 134, 136 these distances apart improves the ability to rigidly couple the tongues 132, 134, 136 of plate 110 to ribs of utility modules (e.g., ribs 234, 238, 264, 268 of utility module 210), such as by providing a distance between the multiple interfaces (e.g., coupling surfaces of tongues and ribs) between plate 110 and the utility module.

Coupling interface 112 includes tongue 152 extending in direction 150 from second sidewall 124 towards first sidewall 122, and extending from rear wall 120 towards front wall 126. Coupling interface 112 also includes tongue 154 extending in direction 150 from second sidewall 124 towards first sidewall 122, and tongue 156 extending in direction 150 from second sidewall 124 towards first sidewall 122. In various embodiments, tongues 152, 154, 156 are symmetrical with respect to tongue 132, 134, 136, and thus similarly spaced from each other.

Referring to FIG. 2, various aspects of utility module 210 are shown. Utility module 210 includes retractable latch 212 extending below bottom surface 214 from front 218 of housing 224, and latch 212 is configured to engage with a latch recess (e.g., latch recess 114).

Utility module 210 includes housing 224 that extends from front 218 to rear 216 opposite front 218 in a direction opposite direction 222. Handle 220 is coupled to front 218 of utility module 210. Housing 224 defines bottom surface 214 and storage compartment 226, which is configured to receive hand tools, among other objects. Utility module 210 includes rear male couplers 230, central male couplers 250, and front male couplers 260, each of which extend from bottom surface 214.

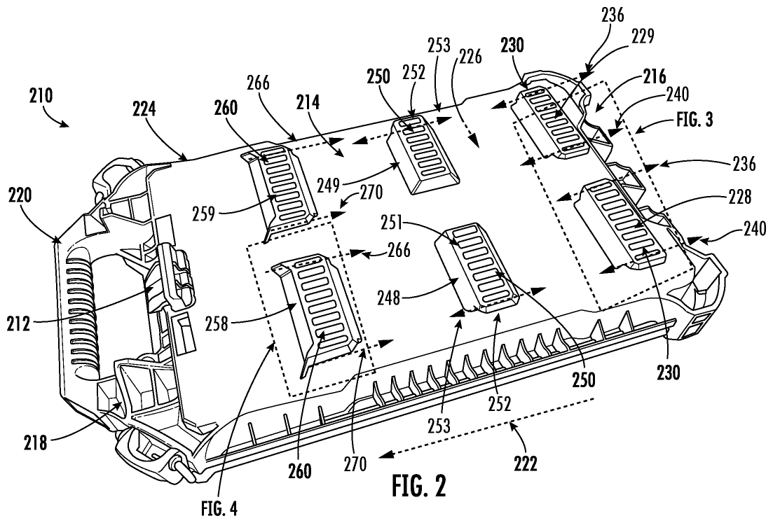

Referring to FIG. 3, rear male couplers 230 (e.g., first rear male coupler 228 and second rear male coupler 229) include central body 232 extending from bottom surface 214, a first rib 234 and second rib 238 extending from central body 232 away from each other. First rib 234 is offset from bottom surface 214 to define first channel 236, and second rib 238 is offset from bottom surface 214 to define second channel 240. In various embodiments, utility module 210 includes two rear male couplers 230, shown as first rear male coupler 228 and second front male coupler 229.

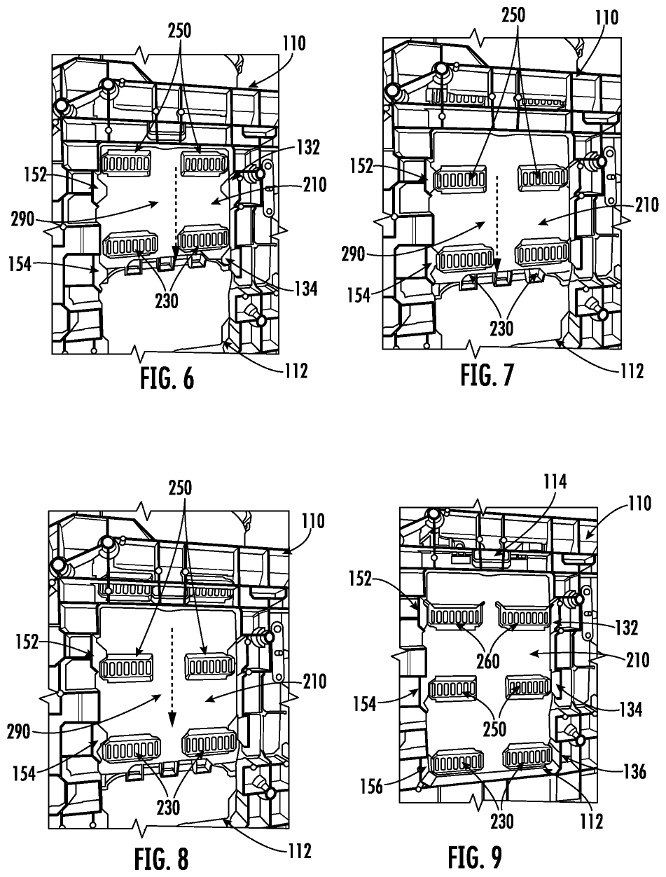

In various embodiments, rear male couplers 230 do not include a rear wall that interrupts channel 236 or channel 240. Stated another way, channel 236 and channel 240 both extend uninterrupted towards front 218 of housing 224. Channel 236 includes a front opening 235 facing towards the front 218 of the utility module 210, and a rear opening 237 facing away from front 218 and towards rear 216 of utility module. Channel 240 includes a front opening 239 facing towards the front 218 of the utility module 210, and a rear opening 241 facing away from front 218 and towards rear 216 of utility module. As will be described below in reference to FIGS. 6-9, the front openings 235, 239 and rear openings 237, 241 of channels 236, 240 permit tongues of couplers (e.g., tongue 132, 134, 136, 152, 154, 156) to slide past rear male couplers 230 when utility module 210 is being engaged to another object (e.g., plate 110). In various embodiments, first front male coupler 258 is between the first rear male coupler 228 and the retractable latch 212. In various embodiments, first front male coupler 258 is between first rear male coupler 228 and front 218 of housing 224.

In various embodiments, central male couplers 250 each include a single tongue facing away from the other central male couplers 250. In various embodiments, central male couplers 250 do not include a rear wall that interrupts the channel beneath the rib, similar to rear male couplers 230.

In various embodiments, utility module 210 includes central male coupler(s) 250, such as first central male coupler 248 and second central male coupler 249, extending from the bottom surface 214. Central male coupler 248 includes a third body 251 extending downward from the bottom surface 214, a fifth rib 252 extending from the third body 251 and offset from the bottom surface 214 to define a fifth channel 253, and the fifth channel 253 is colinear with the first channel 236 (of first rear male coupler 228) and the third channel 266 (of first front male coupler 258).

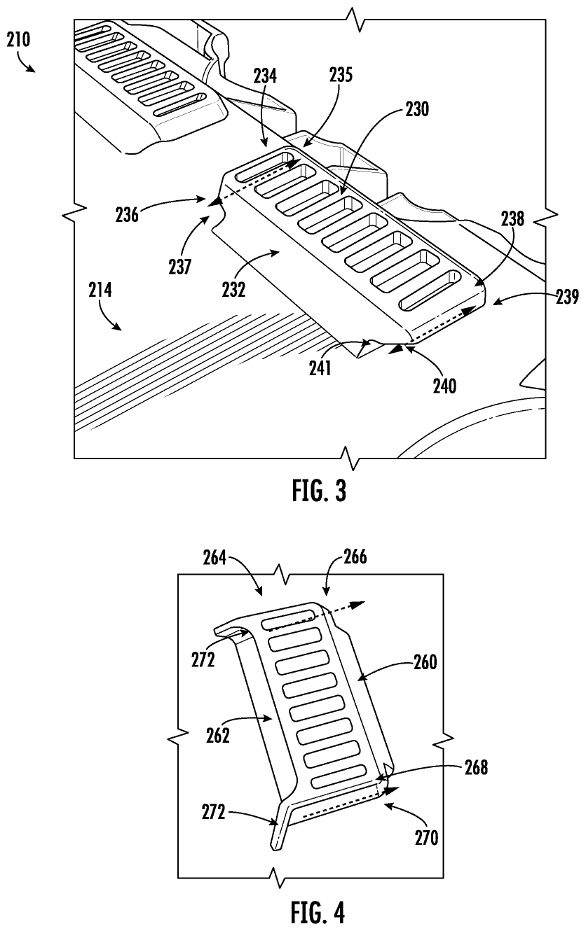

Referring to FIG. 4, front male couplers 260 (e.g., first front male coupler 258 and second front male coupler 259) each include second body 262 extending from bottom surface 214, a third rib 264 and fourth rib 268 extending from second body 262 away from each other. Third rib 264 is offset from bottom surface 214 to define third channel 266, and fourth rib 268 is offset from bottom surface 214 to define fourth channel 270. Front male couplers 260 include rear wall 272 extending from bottom surface 214 and that blocks each of third channel 266 and fourth channel 270 from extending towards front 218 of housing 224. In various embodiments, channel 236 is colinear with channel 266 and channel 240 is colinear with the channel 270.

In various embodiments, utility module 210 includes a second rear male coupler 230, such as second rear male coupler 229, extending from bottom surface 214. Second rear male coupler 229 includes a third body 232 extending downward from bottom surface 214, a fifth rib 234 and a sixth rib 238 extending from the third body 232 away from each other, the fifth rib 234 offset from the bottom surface 214 to define a fifth channel 236, the sixth rib 238 offset from the bottom surface 214 to define a sixth channel 240, and the fifth channel 236 of second rear male coupler 229 and the sixth channel 240 of second rear male coupler 229 each extend uninterrupted towards the front 218 of the housing 224. In various embodiments, fifth channel 236 (of second rear male coupler 229) is parallel to each of the first channel 236 (of first rear male coupler 228) and second channel 240 (of first rear male coupler 228), and sixth channel 240 (of second rear male coupler 229) is parallel to each of first channel 236 (of first rear male coupler 228), second channel 240 (of first rear male coupler 228), and fifth channel 236 (of second rear male coupler 229).

In various embodiments, utility module 210 includes a second front male coupler 260, such as second front male coupler 259, extending from bottom surface 214, second front male coupler 259 including a fourth body 262 extending downward from the bottom surface 214, a seventh rib 264 and a eighth rib 268 extending from the fourth body 262 away from each other, the seventh rib 264 offset from the bottom surface 214 to define a seventh channel 266, the eighth rib 268 offset from the bottom surface 214 to define an eighth channel 270, and the second front male coupler 259 includes a rear wall 272 that blocks each of the seventh channel 266 and the eighth channel 270 from extending towards the front 218 of the housing 224. In various embodiments, seventh channel 266 is colinear with the fifth channel 236 (of second rear male coupler 229) and the eighth channel 270 is colinear with the sixth channel 240 (of second rear male coupler 229).

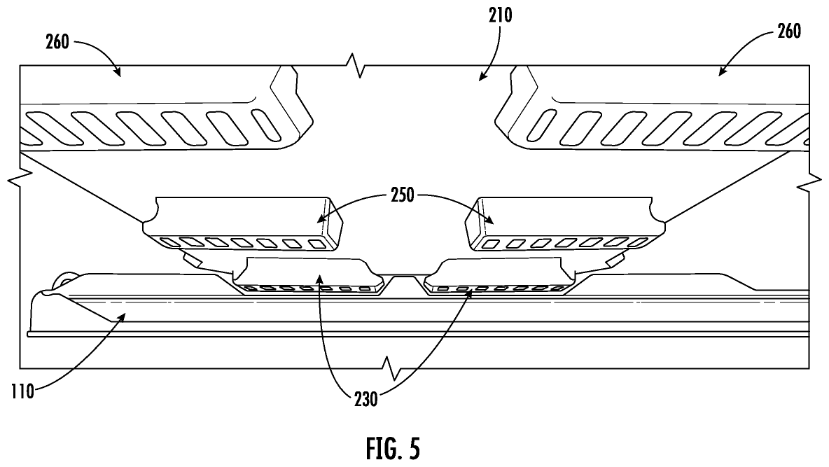

Referring to FIGS. 5-9, various aspects of coupling utility module 210 and plate 110 are shown. Referring to FIGS. 6-8, because rear male couplers 230 and central male couplers 250 do not include rear walls to interface with tongues 132, 134, 152, 154, utility module 210 slides with respect to plate 110 without interference when utility module 210 is being inserted in direction 290. As can be seen, tongues 132, 134, 152, 154 slide under the ribs of rear male couplers 230 and central male couplers 250 and past the tongues of rear male couplers 230 and central male couplers 250. Utility module 210 stops sliding with respect to plate when the rear wall 272 of front male couplers 260 interfaces with tongues 132, 152 (FIG. 9).

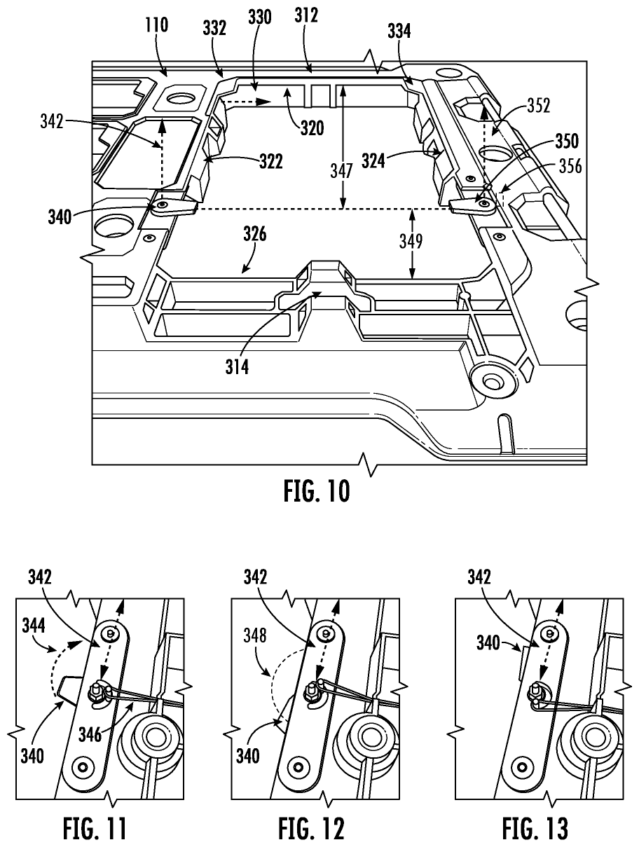

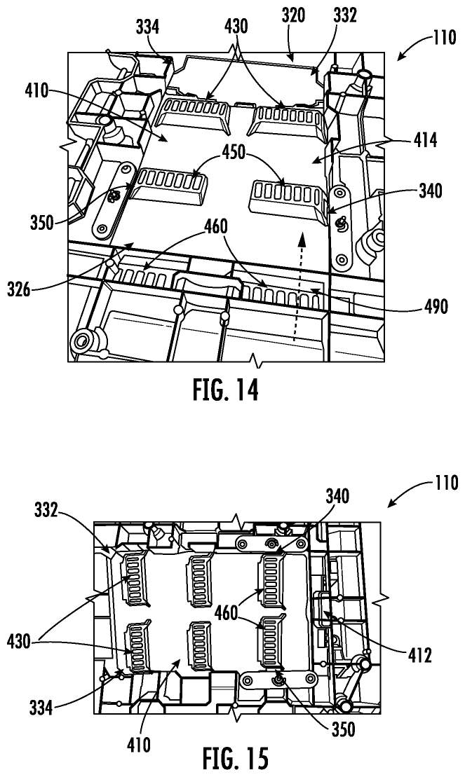

Referring to FIGS. 10-14, various aspects of a support structure, shown as plate 110, and coupling interface 312 are shown. Plate 110 includes latch recess 314 and a coupling interface 312. Coupling interface 312 is configured to slidingly and rigidly engage a utility module (e.g., utility module 410 shown in FIG. 14).

Coupling interface 312 includes rear wall 320, front wall 326 opposite rear wall 320, first sidewall 322 extending between rear wall 320 and front wall 326, and second sidewall 324 opposite first sidewall 322. Second sidewall 324 extends between front wall 326 and rear wall 320. In various embodiments, coupling interface 312 includes latch recess 314 defined by front wall 326.

Coupling interface 312 includes first rib 332 extending in direction 330 from first sidewall 322 towards second sidewall 324, and extending from rear wall 320 towards front wall 326. Coupling interface 312 also includes second rib 334 extending opposite direction 130 from second sidewall 124 towards first sidewall 122.

Coupling interface 312 includes first moveable wing 340 pivotally coupled to first sidewall 322. Moveable wing 340 pivots around axis 342 with respect to first sidewall 322. Moveable wing 340 actuates between extending from axis 342 towards rear wall 320 (FIG. 13), extending from axis 342 towards second sidewall 324 (FIG. 11), and extending from axis 342 towards front wall 326 (FIG. 12). In various embodiments, moveable wing 340 is biased by a first biasing element, shown as rubber band 346, to extend from axis 342 towards rear wall 320 pointing towards second sidewall 324. As will be seen, when utility module 410 (FIG. 14) is inserted into coupling interface 312, moveable wing 340 rotates in direction 344 about axis 342 towards rear wall 320.

In various embodiments, moveable wing 350 is pivotally coupled to second sidewall 324. In various embodiments, moveable wing 350 is substantially the same as moveable wing 340 with the exception that moveable wing 350 is symmetrical with respect to moveable wing 340. Thus, second moveable wing 350 is pivotally coupled to second sidewall 324, the second moveable wing 350 pivoting around a second axis 352 with respect to the second sidewall 324. Moveable wing 350 actuates between extending from the second axis 352 towards the rear wall 320, extending from the second axis 352 towards the first sidewall 322, and extending from the second axis 352 towards the front wall 326. Moveable wing 350 is biased by a second biasing element 356 to extend from the second axis 352 towards the first sidewall 322.

In various embodiments, rubber band 346 biases the first moveable wing 340 to extend from the first axis 342 towards the second axis 352, and the second biasing element 356 biases the second moveable wing 350 to extend from the second axis 352 towards the first axis 342. In various embodiments, rubber band 346 biases first moveable wing 340 to extend perpendicular to first sidewall 322, and second biasing element 356 biases second moveable wing 350 to extend perpendicular to second sidewall 324. In various embodiments, first moveable wing 340 and second moveable wing 350 both pivot over range 348, which is at least 180 degrees.

In various embodiments, first rib 332 is coplanar with first moveable wing 340. In various embodiments, second rib 334 is coplanar with first moveable wing 340 and second moveable wing 350.

In various embodiments, first moveable wing 340 is closer to front wall 326 than rear wall 320, and thus distance 347 between first moveable wing 340 and rear wall 320 is greater than distance 349 between first moveable wing 340 and front wall 326.

Referring to FIGS. 14-15, various aspects of inserting utility module 410 into coupling interface 312 are shown. Utility module 410 is substantially the same as utility module 210 except for the differences described. In particular, rear male couplers 430 and central male couplers 450 of utility module 410 extend from bottom surface 414 and include rear walls that interrupt the channels beneath the tongues.

Utility module 410 moves in direction 490 to be inserted into coupling interface 312. As rear male couplers 430 and central male couplers 450 pass by moveable wings 340 and 350, the rear walls of rear male couplers 430 and central male couplers 450 rotate the moveable wings 340 and 350 towards rear wall 320 (FIG. 14).

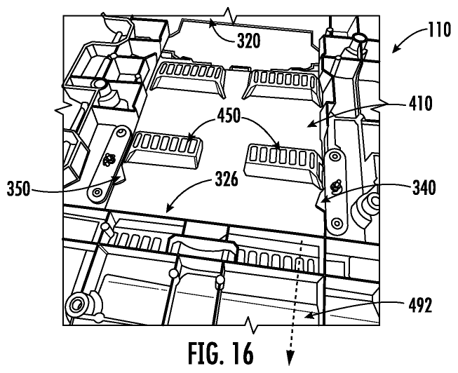

When utility module 410 is rigidly coupled to plate 110 via coupling interface 312, utility module 410 is both laterally secured with respect to plate 110 and vertically secured with respect to plate 110. In particular, latch 412 is received within latch recess 314, thereby laterally securing utility module 410 and plate 110 (FIG. 15). In regard to vertically securing utility module 410 and plate 110, rear male couplers 430 engage with ribs 332, 334, and front male couplers 460 engage with moveable wings 340, 350 (FIG. 15). When utility module 410 is removed from plate 110, utility module 410 is moved in direction 492 with respect to plate 110 and rear walls of central male couplers 450 rotate moveable wings 340, 350 towards front wall 326 (FIG. 16).

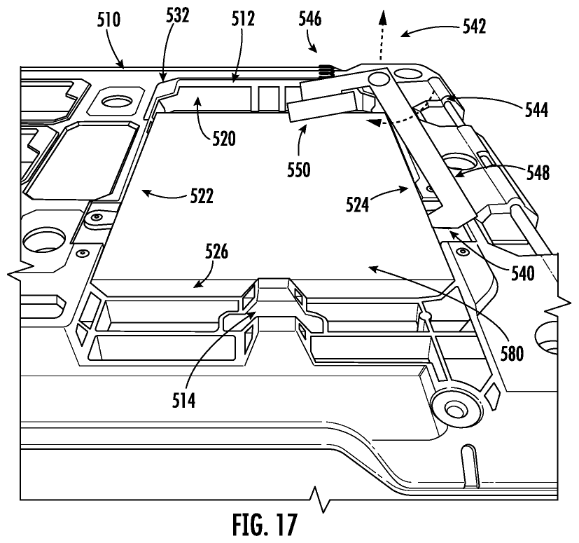

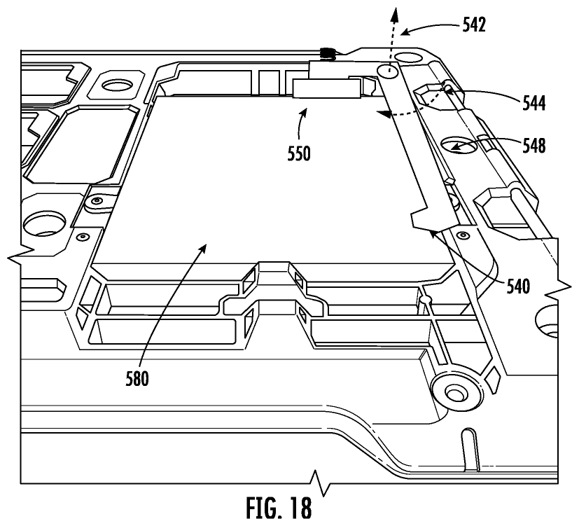

Referring to FIGS. 17-18, various aspects of plate 510 and coupling interface 512 are shown. Coupling interface 512 is substantially the same as coupling interface 312 except as discussed herein. Utility module 580 is substantially the same as utility module 410.

Coupling interface 512 includes rear wall 520, front wall 526 opposite rear wall 520, first sidewall 522 extending between rear wall 520 and front wall 526, second sidewall 524 opposite first sidewall 522, second sidewall 524 extending between rear wall 520 and front wall 526.

In particular, retractable wing 540 is biased by spring 546 to not project past second sidewall 524. As background, retractable wing 540 is coupled to arm 548 that extends between retractable wing 540 and arm 550. Retractable wing 540 actuates between an extended position and a retracted position, and when retractable wing 540 is in the extended position the retractable wing 540 extends past the first sidewall 522 towards the second sidewall 524, and when the retractable wing 540 actuates from the retracted position to the extended position the retractable wing 540 moves towards the second sidewall 524. In various embodiments, when the retractable wing 540 is in the retracted position the retractable wing 540 is retracted behind first sidewall 522.

In use, retractable wing 540, arm 548 and arm 550 rotate around axis 542 with respect to plate 510. In particular, as utility module 580 inserted into coupling interface 512, utility module 580 interfaces with arm 550 thereby biasing retractable wing 540, arm 548 and arm 550 in direction 544 around axis 542 with respect to plate 510 and coupling interface 512. Finally, a latch extending from utility module 580 engages with latch recess 514 to laterally secure and rigidly couple utility module 580 and plate 510.

Coupling interface 512 includes ribs 532, each of which extend from rear wall 520 towards front wall 526. A first rib 532 extends from first sidewall 522 to second sidewall 524 and from rear wall 520 to front wall 526, and a second rib 532 extends from second sidewall 524 to first sidewall 522 and from rear wall 520 to front wall 526. Engagement between tongues of utility module 580 and ribs 532 and retractable wing 540 of coupling interface 512 vertically secure and rigidly couple utility module 580 and plate 510.

In various embodiments, arm 548 is rigidly coupled to retractable wing 540, and arm 548 and retractable wing 540 rotate with respect to first sidewall 522 about axis 542. In various embodiments, a biasing element, shown as spring 546, biases retractable wing 540 towards the retracted position and biases arm 548 to extend past the rear wall 520 towards front wall 526.

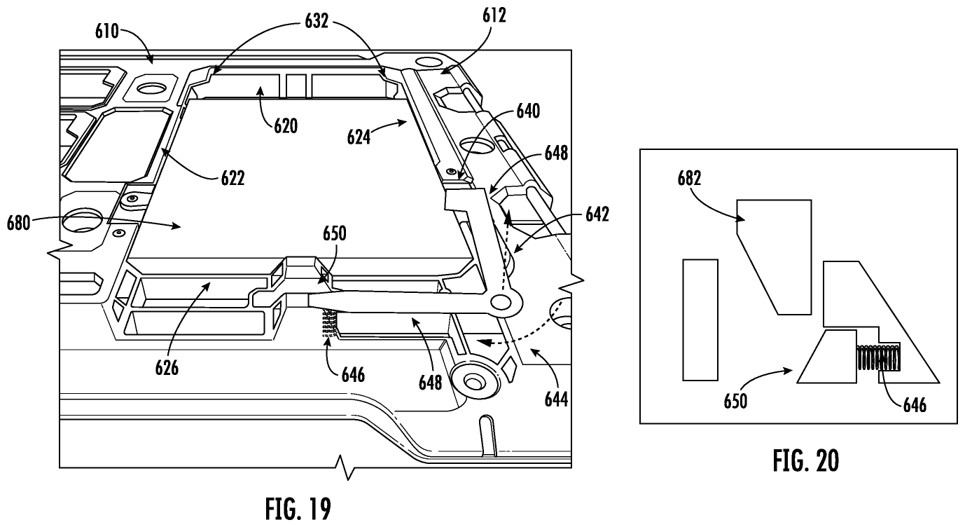

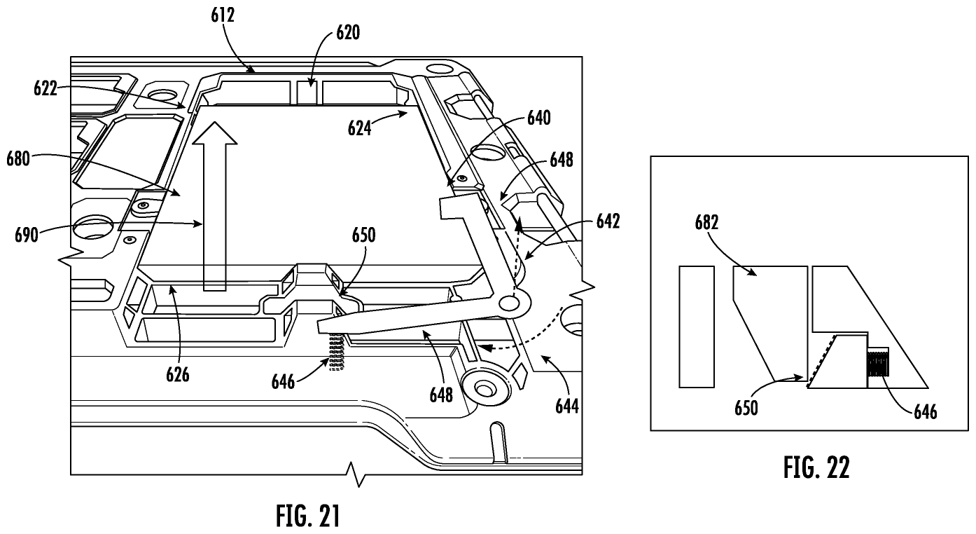

Referring to FIGS. 19-21, various aspects of plate 610 and coupling interface 612 are shown. Coupling interface 612 is substantially the same as coupling interface 312 or coupling interface 512 except as discussed herein. Utility module 680 is substantially the same as utility module 410.

In particular, retractable wing 640 is biased by spring 646 to not project past second sidewall 624. As background, retractable wing 640 is coupled to arm 648 that extends between retractable wing 640 and arm 650.

In use, retractable wing 640, arm 648 and arm 650 rotate around axis 642 with respect to plate 610. In particular, utility module 680 inserted into coupling interface 612 in direction 690 until latch 682 of utility module 680 is inserted into latch recess 614. Latch 682 then interfaces with arm 650, thereby biasing retractable wing 640, arm 648 and arm 650 opposite direction 644 around axis 642 with respect to plate 610 and coupling interface 612.

Coupling interface 612 includes ribs 632, each of which extend from rear wall 620 towards front wall 626. One of ribs 632 extends from first sidewall 622 to second sidewall 624, and the other of ribs 632 extends from second sidewall 624 to first sidewall 622. Engagement between tongues of utility module 680 and ribs 632 and retractable wing 640 of coupling interface 612 vertically secure and rigidly couple utility module 680 and plate 610.

Coupling interface 612 includes rear wall 620, front wall 626 opposite rear wall 620, first sidewall 622 extending between rear wall 620 and front wall 626, second sidewall 624 opposite first sidewall 622, second sidewall 624 extending between rear wall 620 and front wall 626. In various embodiments, coupling interface 612 includes latch recess 614 defined by the front wall 626, arm 648 rigidly coupled to retractable wing 640, the arm 648 and the retractable wing 640 rotating with respect to the first sidewall 622 about axis 642, and a biasing element, shown as spring 646, that biases the retractable wing 640 towards the retracted position and that biases the arm 648 into the latch recess 614.

In various embodiments, the couplers described herein and shown in the figures are compatible with the coupling mechanism(s) described in International Patent International Patent Publication No. WO 2017/191628, which is hereby incorporated by reference in its entirety. In various embodiments, the female couplers and male couplers described herein engage with each other to rigidly couple the utility modules that the female couplers and male couplers extend from.

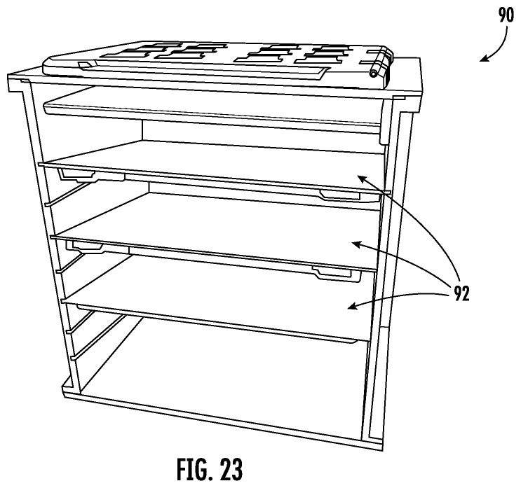

Referring to FIG. 23, various aspects of drawer 90 are shown. In various embodiments, one or more of plate 110, plate 510, or plate 610 are coupled to one of shelves 92.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A support structure comprising a coupling interface, the coupling interface comprising:
a rear wall;
a front wall opposite the rear wall;
a first sidewall extending between the rear wall and the front wall;
a second sidewall opposite the first sidewall, the second sidewall extending between the rear wall and the front wall;
a first rib extending from the first sidewall towards the second sidewall and from the rear wall towards the front wall;
a second rib extending from the second sidewall towards the first sidewall and from the rear wall towards the front wall;
a first moveable wing pivotally coupled to the first sidewall, the first moveable wing pivoting around a first axis with respect to the first sidewall, wherein the first moveable wing actuates between extending from the first axis towards the rear wall, extending from the first axis towards the second sidewall, and extending from the first axis towards the front wall, and wherein the first moveable wing is biased by a first biasing element to extend from the first axis towards the second sidewall; and
a second moveable wing pivotally coupled to the second sidewall, the second moveable wing pivoting around a second axis with respect to the second sidewall, wherein the second moveable wing actuates between extending from the second axis towards the rear wall, extending from the second axis towards the first sidewall, and extending from the second axis towards the front wall, and wherein the second moveable wing is biased by a second biasing element to extend from the second axis towards the first sidewall.

2. The support structure of claim 1, comprising a latch recess defined by the front wall.

3. The support structure of claim 1, wherein the first biasing element biases the first moveable wing to extend from the first axis towards the second axis, and wherein the second biasing element biases the second moveable wing to extend from the second axis towards the first axis.

4. The support structure of claim 1, wherein the first rib is coplanar with the first moveable wing.

5. The support structure of claim 4, wherein the second rib is coplanar with the first moveable wing and the second moveable wing.

6. The support structure of claim 1, wherein the first moveable wing and the second moveable wing both pivot at least 180 degrees.

7. The support structure of claim 1, wherein the first moveable wing is closer to the front wall than the rear wall.

8. The support structure of claim 1, wherein the first biasing element biases the first moveable wing to extend perpendicular to the first sidewall.

9. The support structure of claim 8, wherein the second biasing element biases the second moveable wing to extend perpendicular to the second sidewall.

10. A utility module comprising:
a housing extending from a front to a rear opposite the front;
a bottom surface defined by the housing;
a retractable latch extending below the bottom surface from the front of the housing;
a first rear male coupler extending from the bottom surface, the first rear male coupler comprising a first body extending downward from the bottom surface, a first rib and a second rib extending from the first body away from each other, the first rib offset from the bottom surface to define a first channel, the second rib offset from the bottom surface to define a second channel, and wherein the first channel and the second channel each extend uninterrupted towards the front of the housing; and
a first front male coupler extending from the bottom surface, the first front male coupler comprising a second body extending downward from the bottom surface, a third rib and a fourth rib extending from the second body away from each other, the third rib offset from the bottom surface to define a third channel, the fourth rib offset from the bottom surface to define a fourth channel, the first front male coupler comprising a rear wall that blocks each of the third channel and the fourth channel from extending towards the front of the housing, and wherein the third channel is colinear with the first channel and the fourth channel is colinear with the second channel.

11. The utility module of claim 10, the housing defining a storage compartment configured to receive hand tools.

12. The utility module of claim 10, wherein the first front male coupler is between the first rear male coupler and the front of the housing.

13. The utility module of claim 10, comprising:
a second rear male coupler extending from the bottom surface, the second rear male coupler comprising a third body extending downward from the bottom surface, a fifth rib and a sixth rib extending from the third body away from each other, the fifth rib offset from the bottom surface to define a fifth channel, the sixth rib offset from the bottom surface to define a sixth channel, and wherein the fifth channel and the sixth channel each extend uninterrupted towards the front of the housing.

14. The utility module of claim 13, wherein the fifth channel is parallel to each of the first channel and second channel, and wherein sixth channel is parallel to each of the first channel, the second channel, and the fifth channel.

15. The utility module of claim 13, comprising:
a second front male coupler extending from the bottom surface, the second front male coupler comprising a fourth body extending downward from the bottom surface, a seventh rib and a eighth rib extending from the fourth body away from each other, the seventh rib offset from the bottom surface to define a seventh channel, the eighth rib offset from the bottom surface to define an eighth channel, the second front male coupler comprising a rear wall that blocks each of the seventh channel and the eighth channel from extending towards the front of the housing.

16. The utility module of claim 15, wherein the seventh channel is colinear with the fifth channel and the eighth channel is colinear with the sixth channel.

17. The utility module of claim 10, comprising:
a central male coupler extending from the bottom surface, the central male coupler comprising a third body extending downward from the bottom surface, a fifth rib extending from the third body and offset from the bottom surface to define a fifth channel, wherein the fifth channel is colinear with the first channel and the third channel.

18. A support structure comprising a coupling interface, the coupling interface comprising:
a rear wall;
a front wall opposite the rear wall;
a first sidewall extending between the rear wall and the front wall;
a second sidewall opposite the first sidewall, the second sidewall extending between the rear wall and the front wall;
a first rib extending from the first sidewall towards the second sidewall and from the rear wall towards the front wall;
a second rib extending from the second sidewall towards the first sidewall and from the rear wall towards the front wall; and
a retractable wing, wherein the retractable wing actuates between an extended position and a retracted position, wherein when the retractable wing is in the extended position the retractable wing extends past the first sidewall towards the second sidewall, wherein when the retractable wing actuates from the retracted position to the extended position the retractable wing moves towards the second sidewall.

19. The support structure of claim 18, comprising:
an arm rigidly coupled to the retractable wing, the arm and the retractable wing rotating with respect to the first sidewall about an axis; and
a biasing element that biases the retractable wing towards the retracted position and that biases the arm to extend past the rear wall towards the front wall.

20. The support structure of claim 18, comprising:
a latch recess defined by the front wall;
an arm rigidly coupled to the retractable wing, the arm and the retractable wing rotating with respect to the first sidewall about an axis; and
a biasing element that biases the retractable wing towards the retracted position and that biases the arm into the latch recess.
